(19) United States
(12) Patent Application Publication
(10) Pub. No.: US 2006/0291094 A1
(43) Pub. Date: Dec. 28, 2006

(54) Magnetic recording medium drive capable of suppressing vibration of flexible printed circuit board

(75) Inventors: Masanori Ueda, Kawasaki (JP); Haruyuki Matsunaga, Atsugi (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 11/262,497

(22) Filed: Oct. 27, 2005

(30) Foreign Application Priority Data
Jun. 22, 2005 (JP) 2005-182621

(51) Int. Cl. G11B 17/00

(52) U.S. Cl. 360/97.01

(57) ABSTRACT

A head actuator member supports a head slider at the tip end. A first fixing member is integrated with the enclosure at a position spaced from the head actuator member by a predetermined distance. A second fixing member firmly hold the folded section of a flexible printed circuit board against the first fixing member. The flexible printed circuit board is thus reliably prevented from lifting from the first or second fixing member. The first fixing member is firmly secured to the enclosure. The first fixing member is reliably prevented from shifting and shaking. Even if the head actuator member changes its attitude, the flexible printed circuit board can reliably be prevented from vibration. The head slider can thus be positioned right above a target recording track on the magnetic recording disk with a higher accuracy. Reading and writing of magnetic bit data can be realized with a high accuracy.

### BACKGROUND OF THE INVENTION

1. Field of the Invention

The present invention relates to a magnetic recording medium drive such as a hard disk drive (HDD). In particular, the invention relates to a magnetic recording medium drive including a head actuator and a flexible printed circuit board (FPC) attached to the head actuator.

1. Description of the Prior Art

A flexible printed circuit board (FPC) is interposed between a pair of fixing members, for example, as disclosed in Japanese Patent Application Publication No. 10-69736. The flexible printed circuit board is folded over between the fixing members. The flexible printed circuit board is in this manner turned over within a plane. One of the fixing members is fixed to a chassis, for example. The hooks of the fixing member are fitted into through holes in the chassis based on elastic deformation. The flexible printed circuit board is in this manner attached to the chassis. Such a fixing mechanism is utilized in the optical pickup unit of an optical disk drive.

A head actuator member is incorporated in the enclosure of the hard disk drive, for example. The head actuator member is designed to change its attitude relative to the magnetic recording disk. A head slider is supported at the tip end of the head actuator member. The flexible printed circuit board is attached to the head actuator member. The flexible printed circuit board extends to the fixing members spaced from the head actuator member by a predetermined distance. The tip end of the flexible printed circuit board is connected to a printed circuit board. The head slider is thus allowed to receive sensing and writing currents from the printed circuit board through the flexible printed circuit board.

An adhesive tape, for example, is utilized to attach the flexible printed circuit board to the surface of the fixing member in the hard disk drive. In such a case, the flexible printed circuit board suffers from lifting from the fixing member when folded. This results in undesirable vibration of the flexible printed circuit board. Moreover, chemicals and dust diffuse out of the adhesive tape within the enclosure. On the other hand, a metallic holder such as a clip is utilized to hold the fixing members and the flexible printed circuit board when the flexible printed circuit board is to be fixed. In this case, the clip is an additional component in the hard disk drive. The production cost of the hard disk drive thus gets increased. The flexible printed circuit board suffers from scratches due to contact or friction with the clip. The scratches cause generation of dust within the enclosure. Dust hinders reading and writing operations of magnetic bit data.

Now, assume that the fixing members of the aforementioned publication are attached to the enclosure of the hard disk drive. The head actuator member intermittently repeats swinging movement around a vertical support shaft. This allows the flexible printed circuit board to swing. Since the hooks of the fixing member are solely fitted into through holes in the bottom plate of the enclosure based on elastic deformation, the fixing member is forced to suffer from a shift or shake based on the elastic deformation of the hooks during the swinging movement of the flexible printed circuit board. Undesirable vibration is thus induced in the flexible printed circuit board. The vibration is transmitted to the head slider. The head slider cannot be positioned with accuracy because of the vibration. This hinders the reading and writing operations of magnetic bit data.

### SUMMARY OF THE INVENTION

It is accordingly an object of the present invention to provide a magnetic recording medium drive capable of suppressing vibration of a flexible printed circuit board when a head actuator changes its attitude. It is also an object of the present invention to provide an enclosure apparatus greatly contributing to realization of the magnetic recording medium drive.

According to the present invention, there is provided a magnetic recording medium drive comprising: an enclosure; a magnetic recording disk enclosed within the enclosure; a head actuator member supporting a head slider at the tip end of the head actuator member, said head actuator member changing its attitude relative to the magnetic recording disk; a first fixing member spaced from the head actuator member by a predetermined distance, said first fixing member integrated with the enclosure; a flexible printed circuit board extending at least from the head actuator member to the first fixing member, said flexible printed circuit board superposed on the surface of the first fixing member at a folded section of the flexible printed circuit board; and a second fixing member opposing its surface to the surface of the first fixing member, said second fixing member holding at least the folded section of the flexible printed circuit board against the first fixing member.

The magnetic recording medium drive allows the interposal of the folded section of the flexible printed circuit board between the first and second fixing members. The flexible printed circuit board is thus reliably prevented from lifting from the first or second fixing member. In addition, the first fixing member is integrated to the enclosure as a one-piece component. In other words, the first fixing member is firmly secured to the enclosure. The first fixing member is reliably prevented from shifting and shaking. Even if the head actuator member changes its attitude relative to the magnetic recording disk, the flexible printed circuit board can reliably be prevented from undesirable vibration. Vibration of the head actuator member or the head slider can thus reliably be avoided. The head slider can thus be positioned right above a target recording track on the magnetic recording disk with a higher accuracy. Reading and writing of magnetic bit data can be realized with a high accuracy.

Moreover, the first and second fixing members are employed to fix the flexible printed circuit board with the flexible printed circuit board interposed therebetween. Neither an adhesive nor an adhesive tape, for example, is applied to the first and second fixing members. Diffusion of chemicals due to an adhesive material is thus reliably avoided within the enclosure. Generation of dust due to an adhesive material is also avoided within the enclosure. No metallic holder such as a clip is necessary to fix the flexible printed circuit board. The flexible printed circuit board can thus be prevented from scratches caused by contact or friction with a metallic holder. Generation of dust can thus be avoided.

The magnetic recording medium drive may further comprise: a connector attached on the flexible printed circuit board, said connector received in an opening defined in the bottom plate of the enclosure; a first flat surface defined on the second fixing member, said first flat surface urged against the folded section of the flexible printed circuit board; a second flat surface defined on the second fixing member, said second flat surface set perpendicular to the first flat surface, said second flat surface urged against the flexible printed circuit board at least around the opening; and a packing interposed between the flexible printed circuit board and the bottom plate of the enclosure around the opening.

The second fixing member is urged against the flexible printed circuit board at the first and second flat surfaces perpendicular to each other. The flexible printed circuit board is urged against the first fixing member and the bottom plate of the enclosure. The flexible printed circuit board can in this manner firmly be interposed between the first and second fixing members. In addition, the second flat surface serves to urge the flexible printed circuit board against the bottom plate of the enclosure. The packing is interposed between the flexible printed circuit board and the bottom plate of the enclosure around the opening. The packing serves to seal the space between the flexible printed circuit board and the bottom plate of the enclosure. Dust is thus prevented from getting into the inside of the enclosure through the opening.

An enclosure apparatus may be provided for realizing the magnetic recording medium drive. The enclosure apparatus may comprise: an enclosure; a first fixing member integrated with the enclosure; a flexible printed circuit board extending to the first fixing member within the enclosure, said flexible printed circuit board superposed on the surface of the first fixing member at a folded section of the flexible printed circuit board; and a second fixing member opposing its surface to the surface of the first fixing member, said second fixing member holding at least the folded section of the flexible printed circuit board against the first fixing member.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive (HDD) as an example of a magnetic recording medium drive according to the present invention;

FIG. 2 is an enlarged partial perspective view schematically illustrating the structure of first and second fixing members;

FIG. 3 is an enlarged partial perspective view schematically illustrating the structure of a first flexible printed circuit board; and

FIG. 4 is an enlarged vertical sectional view taken along the line 4-4 in FIG. 1.

### DESCRIPTION OF THE PREFERRED EMBODIMENT

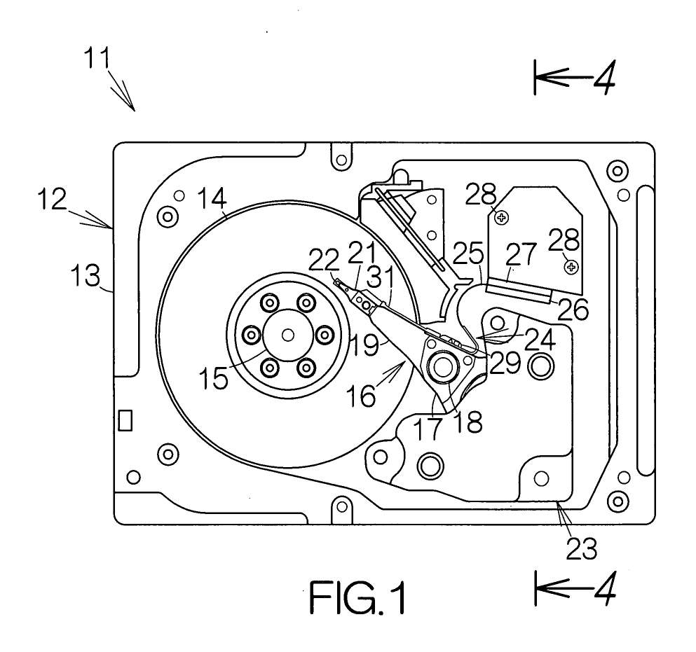

FIG. 1 schematically illustrates the inner structure of a hard disk drive, HDD, 11 as an example of a magnetic recording medium drive according to the present invention. The hard disk drive 11 includes a box-shaped enclosure 12. The enclosure 12 includes a boxed-shaped base 13 defining an inner space of a flat parallelepiped, for example. The base 13 may be made of a metallic material such as aluminum, for example. Casting process may be employed to form the base 13. A cover, not shown, is coupled to the base 13. The cover serves to close the opening of the inner space within the base 13. Metal stamping process may be employed to form the cover out of a plate material, for example.

At least one magnetic recording disk 14 as a recording medium is incorporated within the inner space of the base 13. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A head actuator member 16 is also incorporated within the inner space of the base 13. The head actuator member 16 includes an actuator block 17. The actuator block 17 is supported on a vertical support shaft 18 for relative rotation. The rotation of the actuator block 17 around the vertical support shaft 18 allows the head actuator member 16 to change its attitude relative to the magnetic recording disk or disks 14. Rigid actuator arms 19 are defined on the actuator block 17. The actuator arms 19 are designed to extend in a horizontal direction from the vertical support shaft 18. The actuator arms 19 are respectively related to the front and back surfaces of the magnetic recording disk or disks 14. The actuator block 17 may be made of aluminum, for example. Casting process may be employed to form the actuator block 17, for example.

A head suspension 21 is attached to the tip end of the individual actuator arm 19. The head suspension 21 is designed to extend forward from the corresponding tip end of the actuator arm 19. A flying head slider 22 is supported at the tip or front end of the head suspension 21. The flying head slider 22 is opposed to the surface of the magnetic recording disk 14. As conventionally known, in the case where the magnetic recording disks 14 are incorporated in the enclosure 12, a pair of the actuator arms 19 or head suspensions 21 is located between the adjacent magnetic recording disks 14.

An electromagnetic transducer, not shown, is mounted on the flying head slider 22. The electromagnetic transducer may include a read element and a write element. The read element may include a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example. The write element may include a thin film magnetic head designed to write magnetic bit data into the magnetic recording disk 14 by utilizing a magnetic field induced at a thin film coil pattern.

The head suspension 21 serves to urge the flying head slider 22 toward the surface of the magnetic recording disk 14. The flying head slider 22 is allowed to receive airflow generated along the rotating magnetic recording disk 14. The airflow serves to generate positive pressure or a lift acting on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the lift.

A voice coil motor, VCM, 23 as a power source is coupled to the actuator block 17. The vice coil motor 23 drives the actuator block 17 for rotation around the vertical support shaft 18. The rotation of the actuator block 17 realizes the swinging movement of the actuator arms 19 and the head suspensions 21. When the actuator arm 19 is driven to swing around the vertical support shaft 18 during the flight of the flying head slider 22, the flying head slider 22 is allowed to move along the radial direction of the magnetic recording disk 14. The electromagnetic transducer on the flying head slider 22 can thus be positioned right above a target recording track on the magnetic recording disk 14.

A flexible printed circuit board (FPC) unit 14 is placed on the actuator block 17. The flexible printed circuit board unit 24 includes a first flexible printed circuit board, FPC, 25. The first flexible printed circuit board 25 is attached to the side surface of the actuator block 17 at one end. The other end of the first flexible printed circuit board 25 reaches first and second fixing members 26, 27 both spaced from the head actuator member 16 by a predetermined distance. The first flexible printed circuit board 25 bends between the head actuator block 17 and the first and second fixing members 26, 27. The first fixing member 26 and the base 13 are integrated into a one-piece component. The second fixing member 27 is a member separate from the base 13. The second fixing member 27 is opposed to the first fixing member 26. The first flexible printed circuit board 25 is interposed between the first and second fixing members 26, 27. Screws 28 may be employed to fix the second fixing member 27 on the bottom plate of the base 13. Here, the base 13, the first flexible printed circuit board 25 and the first and second fixing members 26, 27 in combination establish an enclosure apparatus according to the present invention.

A head IC (integrated circuit) or preamplifier IC 29 is mounted on the surface of the first flexible printed circuit board 25. The preamplifier IC 29 is designed to supply the read element of the electromagnetic transducer with a sensing current when magnetic bit data is to be read. The preamplifier IC 29 is also designed to supply the write element in the electromagnetic transducer with a writing current when magnetic bit data is to be written. The preamplifier IC 29 on the flexible printed circuit board unit 24 is designed to receive the sensing and writing currents from a printed circuit board, not shown, attached to the back surface of the bottom plate of the base 13, as described later.

Second flexible printed circuit boards, FPCs, 31 are utilized to supply the sensing current and the writing current. The individual second flexible printed circuit board 31 extends from the corresponding head suspension 21 to the actuator block 17. The front end of the second flexible printed circuit board 31 is overlaid on the surface of the corresponding head suspension 21. Wiring patterns on the second flexible printed circuit board 31 are connected to the corresponding flying head slider 22. The rear end of the second flexible printed circuit board 31 is received on the first flexible printed circuit board 25 on the actuator block 17. The wiring patterns on the second flexible printed circuit board 31 are connected to wiring patterns on the first flexible printed circuit board 25. Electric connection is in this manner established between the flying head slider 22 and the flexible printed circuit board unit 24. The second flexible printed circuit boards 31 may be related to the individual actuator arms 19.

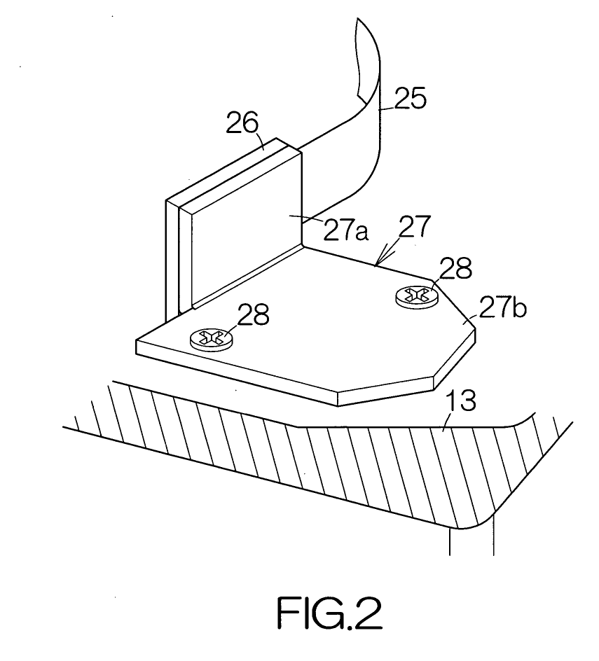

As shown in FIG. 2, the first fixing member 26 is a plate piece standing upright from the bottom plate of the base 13. The second fixing member 27 comprises first and second plate pieces 27a, 27b. The first plate piece 27a is designed to stand upright from the bottom plate of the base 13. The second plate piece 27b perpendicularly extends from the first plate piece 27a. The second plate piece 27b is received on the upper surface of the bottom plate of the base 13. The outward back surface of the first plate piece 27a is opposed to the surface of the first fixing member 26. The first and second plate pieces 27a, 27b are integrated into a one-piece component. The second fixing member 27 may be made of a metallic material, a resin material, or the like, for example.

As shown in FIG. 3, the first flexible printed circuit board 25 is folded over at an imaginary line 32. The first flexible printed circuit board 25 in this manner defines a first section 25a extending from the imaginary line 32 toward the head actuator member 16. The first section 25a extends along an imaginary flat surface and an imaginary curved surface, both set upright to the surface of the bottom plate of the base 13. A second section 25b is also defined in the first flexible printed circuit board 25 so as to extend from the imaginary line 32 toward the bottom plate in the direction perpendicular to the surface of the bottom plate. The second section 25b is perpendicularly bent at the surface of the bottom plate so as to extend within an imaginary plane parallel to the surface of the bottom plate.

The first and second sections 25a, 25b are partly superposed on each other at an extent adjacent to the imaginary line 32. A folded section 25c is in this manner defined in the first flexible printed circuit board 25. The folded section 25c covers the extent where the first and second sections 25a, 25b are superposed on each other. The back surface of the first flexible printed circuit board 25 in the first section 25a contacts with the back surface of the first flexible printed circuit board 25 in the second section 25b at the folded section 25c. The folded section 25c of the first flexible printed circuit board 25 is interposed between the first and second fixing members 26, 27.

The second section 25b of the first flexible printed circuit board 25 is interposed between the second plate piece 27b of the second fixing member 27 and the upper surface of the bottom plate of the base 13, as described later in detail. A pair of through holes 33, 33 is formed in the second section 25b. The through holes 33, 33 receive insertion of the aforementioned screws 28, 28.

The back surface 34 of the first flexible printed circuit board 25 in the first section 25a is received on the side surface of the actuator block 17. The folded section 25c allows the front surface 35 of the first flexible printed circuit board 25 to contact with the surface of the first fixing member 26 and the outward surface of the first plate piece 27a of the second fixing member 27. On the other hand, the upward back surface 34 of the first flexible printed circuit board 25 in the second section 25b receives the downward surface of the second plate piece 27b of the second fixing member 27. The downward front surface 35 of the first flexible printed circuit board 25 in the second section 25b is opposed to the upper surface of the bottom plate of the base 13.

The first flexible printed circuit board 25 includes an insulating thin film. An electrically-conductive layer is overlaid on the surface of the insulating thin film. An insulating protection layer is overlaid on the surface of the electrically-conductive layer. The electrically-conductive layer provides wiring patterns extending on the first flexible printed circuit board 25. An electrically-conductive material such as Cu may be employed to form the electrically-conductive layer. A resin material such as polyimide resin may be employed to provide the insulating thin film and protection layer. An adhesive layer may be interposed between the insulating thin film and the electrically-conductive layer as well as between the electrically-conductive layer and the insulating protection layer. Pads are exposed at the ends of the wiring patterns on the downward front surface 35 of the first flexible printed circuit board 25. The front surface 35 of the first flexible printed circuit board 25 is connected to a connector and the second flexible printed circuit boards 31. The connector will be described later.

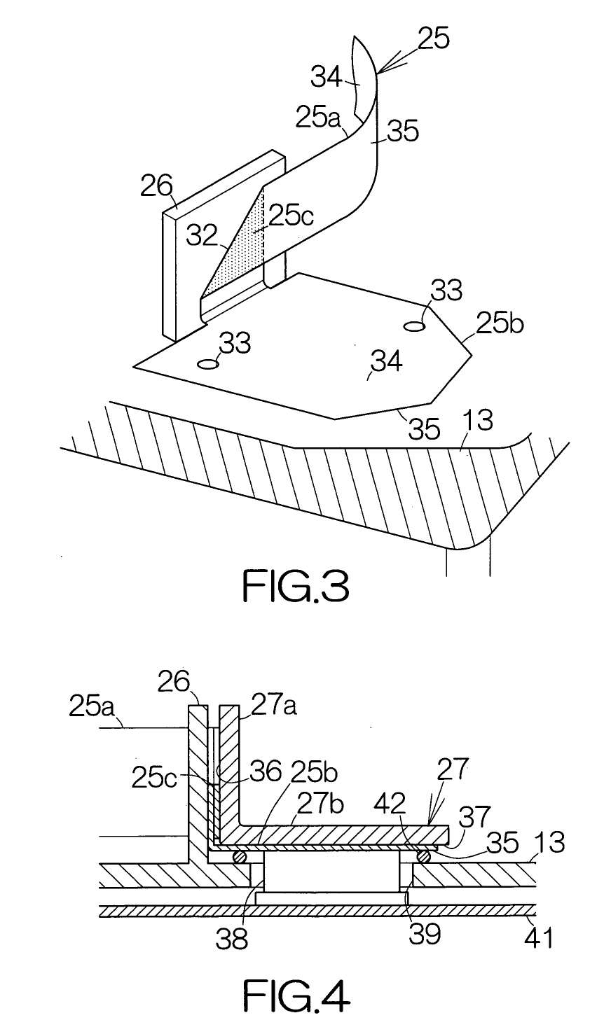

As shown in FIG. 4, the second fixing member 27 is urged against the surface of the first fixing member 26 at the outward surface of the first plate piece 27a, namely a first flat surface 36. The folded section 25c of the first flexible printed circuit board 25 is interposed between the surface of the first fixing member 26 and the first flat surface 36. The second fixing member 27 is also urged against the second section 25b of the first flexible printed circuit board 25 at the outward surface of the second plate piece 27b, namely a second flat surface 37. The second flat surface 37 is set perpendicular to the first flat surface 36. The folded and second sections 25c, 25b of the first flexible printed circuit board 25 are thus allowed to extend along the first and second flat surfaces 36, 37.

The connector 38 is attached to the downward front surface of the first flexible printed circuit board 25 in the second section 25b. The connector 38 is connected to the wiring patterns on the first flexible printed circuit board 25. The connector 38 is located in a space between the aforementioned through holes 33, 33 on the second section 25b. The connector 38 is received in an opening 39 defined in the bottom plate of the base 13. The connector 38 is connected to a printed circuit board 41 attached to the back surface of the bottom plate of the base 13. The sensing and writing currents are thus supplied from the printed circuit board 41 to the flying head sliders 22 through the first and second flexible printed circuit boards 25, 31. A packing 42 is interposed between the downward front surface 35 of the first flexible printed circuit board 25 and the upper surface of the bottom plate of the base 13 around the opening 39. The packing 42 is allowed to endlessly surround the opening 39. The packing 42 may be made of an elastic resin material, for example.

The hard disk drive 11 allows interposal of the folded section 25c of the first flexible printed circuit board 25 between the first and second fixing members 26, 27. The first flexible printed circuit board 25 is thus prevented from lifting from the first and second fixing members 26, 27. In addition, since the first fixing member 26 is integrated to the bottom plate of the base 13 so as to form a one-piece component, the first fixing member 26 is firmly secured to the bottom plate of the base 13. The first fixing member 26 is thus reliably prevented from shifting and shaking. Even if the head actuator member 16 intermittently rotates around the vertical support shaft 18, the first flexible printed circuit board 25 is reliably prevented from vibration. The head actuator member 16 and the flying head slider 22 are reliably prevented from undesirable vibration. The electromagnetic transducer on the flying head slider 22 can thus be positioned right above a target recording track on the magnetic recording disk 14 with a higher accuracy. Reading and writing of magnetic bit data can be realized with a high accuracy.

The first and second fixing members 26, 27 are employed to fix the first flexible printed circuit board 25 with the first flexible printed circuit board 25 interposed therebetween. Neither an adhesive nor an adhesive tape, for example, is applied to the first and second fixing members 26, 27. Diffusion of chemicals due to an adhesive is thus reliably avoided within the enclosure 12. Generation of dust due to an adhesive is also avoided within the enclosure 12. No metallic holder such as a clip is necessary to fix the first flexible printed circuit board 25. The first flexible printed circuit board 25 can thus be prevented from scratches caused by contact or friction with a metallic holder. Generation of dust can thus be avoided.

The second fixing member 27 is urged against the first flexible printed circuit board 25 at the first and second flat surfaces 36, 37 perpendicular to each other. The first flexible printed circuit board 25 is urged against the first fixing member 26 and the surface of the bottom plate of the base 13. The first flexible printed circuit board 25 can in this manner firmly be interposed between the first and second fixing members 26, 27. In addition, the second flat surface 37 serves to urge the first flexible printed circuit board 25 against the bottom plate of the base 13. The packing 41 is interposed between the first flexible printed circuit board 25 and the upper surface of the bottom plate of the base 13 around the opening 39. The packing 42 serves to seal the space between the first flexible printed circuit board and the bottom plate of the enclosure 12. Despite the connection between the connector 38 and the printed circuit board 41 through the opening 39, dust is thus prevented from getting into the inside of the enclosure 12 through the opening 39.

What is claimed is:

1. A magnetic recording medium drive comprising:
an enclosure;
a magnetic recording disk enclosed within the enclosure;
a head actuator member supporting a head slider at a tip end of the head actuator member, said head actuator member changing an attitude relative to the magnetic recording disk;
a first fixing member spaced from the head actuator member by a predetermined distance, said first fixing member integrated with the enclosure;
a flexible printed circuit board extending at least from the head actuator member to the first fixing member, said flexible printed circuit board superposed on a surface of the first fixing member at a folded section of the flexible printed circuit board; and
a second fixing member opposing a surface to the surface of the first fixing member, said second fixing member holding at least the folded section of the flexible printed circuit board against the first fixing member.

2. The magnetic recording medium drive according to claim 1, further comprising:
a connector attached on the flexible printed circuit board, said connector received in an opening defined in a bottom plate of the enclosure;
a first flat surface defined on the second fixing member, said first flat surface urged against the folded section of the flexible printed circuit board;
a second flat surface defined on the second fixing member, said second flat surface set perpendicular to the first flat surface, said second flat surface urged against the flexible printed circuit board at least around the opening; and
a packing interposed between the flexible printed circuit board and the bottom plate of the enclosure around the opening.

3. An enclosure apparatus comprising:
an enclosure;
a first fixing member integrated with the enclosure;
a flexible printed circuit board extending to the first fixing member within the enclosure, said flexible printed circuit board superposed on a surface of the first fixing member at a folded section of the flexible printed circuit board; and
a second fixing member opposing a surface to the surface of the first fixing member, said second fixing member holding at least the folded section of the flexible printed circuit board against the first fixing member.
